(19) United States
(12) Patent Application Publication
(10) Pub. No.: US 2025/0041770 A1
(43) Pub. Date: Feb. 6, 2025

(54) ARRANGEMENT WITH A FILTER ELEMENT AND A CHARGE ABSORPTION ELEMENT, FILTER DEVICE, TANK SYSTEM AND METHOD

(71) Applicant: ARGO-HYTOS GROUP AG, Baar (CH)

(72) Inventors: Daniel TRUNNER, Kraichtal (DE); Roman WEIDEMANN, Östringen (DE); Patrice MAX, Kraichtal (DE); Roberto STIEGELE, Sinsheim (DE); Matthias BAUMANN, Graben-Neudorf (DE); Tobias WENDEL, Bad Schönborn (DE); Thomas WEISER, Bietigheim-Bissingen (DE); Timo SPECK, Ubstadt-Weiher (DE)

(21) Appl. No.: 18/922,485

(22) Filed: Oct. 22, 2024

Related U.S. Application Data
(63) Continuation of application No. PCT/EP2023/060565, filed on Apr. 24, 2023.

(30) Foreign Application Priority Data
Apr. 25, 2022 (DE) 10 2022 109 862.1

(51) Int. Cl. B01D 29/21; B01D 29/23; B01D 29/58

(52) U.S. Cl. CPC B01D 29/21; B01D 29/23; B01D 29/58; B01D 2201/50

(57) ABSTRACT

An arrangement includes a filter element for filtering a liquid, in particular hydraulic oil, and at least one charge absorption element for receiving electrically charged particles of the liquid. The filter element and the charge absorption element are electrically conductive, and the filter element has at least one filter layer with a filter layer surface. The filter layer surface and the charge absorption element can be passed through by the liquid and a charge separation takes place at the filter layer surface as the liquid flows through. The charge absorption element is electrically connected to the filter element such that during operation the charge separation is equalized between the charge absorption element and the filter layer surface. The charge absorption element is connected downstream of the filter element in the direction of flow. A filter device, a tank system and a method for charge equalization are also provided.

### CROSS-REFERENCE TO RELATED APPLICATION

This application is a continuation, under 35 U.S.C. § 120, of copending International Patent Application PCT/EP2023/060565, filed Apr. 24, 2023, which designated the United States; this application also claims the priority, under 35 U.S.C. § 119, of German Patent Application DE 10 2022 109 862.1, filed Apr. 25, 2022; the prior applications are herewith incorporated by reference in their entirety.

### FIELD AND BACKGROUND OF THE INVENTION

The invention relates to an arrangement with a filter element and a charge absorption element, a filter device and a tank system with such an arrangement as well as a method for charge equalization between a filter element and a liquid. Such an arrangement is known, for example, from International Publication WO 2021/055246 A1.

In the field of mobile machinery, such as construction machinery, agricultural machinery and the like, the aim is increasingly to increase energy efficiency, reduce emissions and increase ease of use. In addition, cost efficiency plays a major role from the development to the assembly of such machines. That places increased demands on the hydraulic systems used in the machines.

Such hydraulic systems are often equipped with a hydraulic tank and a filter device to filter hydraulic oil and supply the filtered hydraulic oil to downstream components. During the operation of those hydraulic systems, the problem arises that during the filtration of the hydraulic oil, a charge separation takes place between the oil and a filter element of the filter device. Specifically, the charge separation takes place on a filter layer surface of the filter element. The filter layer surface and the hydraulic oil are charged in opposite directions. In general, the higher the speed at which the oil flows through the filter element, the higher the electrical charging of the oil and the filter element. In the past, that was not a major problem, since the hydraulic oils used had increased electrical conductivity. As hydraulic oils are now generally subject to higher quality and environmental requirements, hydraulic oils with lower conductivity are predominantly used. That has the disadvantage that the hydraulic oil can no longer compensate for the charging process itself and becomes heavily charged. The highly charged oil causes an unwanted electric field to form in the hydraulic tank, which can negatively affect or even destroy surrounding electronic components, for example.

Various solutions are known from the prior art for preventing the charging of hydraulic components. For example, the aforementioned International Publication WO 2021/055246 A1 describes a filter element in which the charge separation on the filter layer surface is equalized by a circuit between a support tube and the filter layer. That fundamentally achieves electroneutrality of the filter element as such. The disadvantage thereof, however, is that only the charging of the filter element is prevented or reduced, but not the charging of the oil.

### SUMMARY OF THE INVENTION

It is accordingly an object of the invention to provide an arrangement with a filter element and a charge absorption element, a filter device, a tank system and a method, which overcome the hereinafore-mentioned disadvantages of the heretofore-known devices and methods of this general type, which make it possible to equalize a charge separation between a filtered liquid and a filter element, thereby reducing the charging of the liquid and the strength of an electric field, and which provide a filter device, a tank system and a method for charge equalization.

With the foregoing and other objects in view there is provided, in accordance with an aspect of the invention, an arrangement with a filter element for filtering a liquid, in particular hydraulic oil, and at least one charge absorption element for absorbing electrically charged particles of the liquid. The filter element and the charge absorption element are electrically conductive. The filter element has at least one filter layer with a filter layer surface. The liquid can flow through the filter layer surface and the charge absorption element. Charge separation occurs on the filter layer surface as the liquid flows through.

According to the invention, the charge absorption element is electrically connected to the filter element in such a way that, during operation, charge separation is equalized between the charge absorption element and the filter layer surface, wherein the charge absorption element is disposed downstream of the filter element in the direction of flow.

The invention has the advantage that the charge separation that takes place on the filter layer surface when the liquid flows through the filter layer is equalized again. As a result, the electrostatic charge of the filter element and the liquid is considerably reduced or even is prevented. This has the great advantage that only a very low electric field is formed between the filter element and the liquid. It is generally known that strong electric fields can negatively influence or destroy electronic components. The arrangement according to the invention of a filter element and a charge absorption element prevents this. The advantage of this is that additional shielding to protect electronic components can be dispensed with, thus saving costs.

When the arrangement is in use, a liquid to be filtered flows through the filter layer of the filter element. As the liquid flows through the filter layer, a charge separation occurs on the filter layer surface. The filter layer surface and the liquid are charged in opposite directions. For example, the filter layer surface can be negatively charged, i.e. have an excess of electrons, and the filtered liquid can be positively charged, i.e. have a lack of electrons. Alternatively, it is possible that due to the charge separation, the filter layer surface is positively charged and the liquid is negatively charged. Depending on the corresponding charge, the filter layer surface and the liquid each have an opposite polarity. Charge carriers in the liquid are ions.

After flowing through, the filtered and charged liquid emerges from the filter layer. For this purpose, the filter element has an outflow side that is part of the filter layer. The charged liquid flows downstream of the filter element into a charge absorption element, which is electrically coupled to the filter element.

As the filter layer surface and the liquid are oppositely charged, there is an increased potential difference between them. Preferably, the filter layer surface and the liquid have the same charge value of different signs. In other words, a charge value of the charge of the filter layer surface corresponds to a charge value of the liquid, wherein the two charge values have opposite signs. In the context of the invention, the opposing charges generate an electrostatic field in which the field strength is specified in the unit of kilovolts (kV).

Due to the high potential difference between the filter layer surface and the liquid, the liquid releases charged particles to the charge absorption element or absorbs charged particles from the charge absorption element. This depends on the polarity of the charged filter layer surface and the charged liquid. Depending on the polarity, these charged particles are transported through the electrical connection between the filter element and the charge absorption element so that the charge separation is equalized. Specifically, electrons are moved between the filter layer surface and the charge absorption element to equalize the charge separation. Due to the “liquid/charge absorption element” surface pairing and the electrically conductive connection between the charge absorption element and the filter element, charges can move back and forth between the filter layer surface and the liquid to equalize the charge separation.

The charge absorption element is preferably fully electrically conductive. Alternatively, the charge absorption element can be electrically conductive in portions. The charge absorption element serves to absorb charges from the liquid and/or to release charges to the liquid. The charge absorption element thus forms at least one manner of charge transfer. During operation, the liquid flows through the charge absorption element in the direction of flow downstream of the filter element. The charge absorption element preferably provides at least one contact surface for the liquid in order to absorb charges from the liquid or to release charges to the liquid. The at least one contact surface is preferably electrically conductive. Particularly preferably, the charge absorption element is configured in such a way that the liquid, before it exits, comes into contact with a plurality of contact surfaces of the charge absorption element for charge equalization.

The charge absorption element preferably includes an inlet and an outlet region for the filtered liquid. The charge absorption element is preferably formed such that at least one flow path between the inlet region and the outlet region has a length that is longer than a shortest flow path between the inlet region and the outlet region. In other words, the charge absorption element is configured in such a way that a flow path between the inlet and outlet regions is longer than a minimal flow path. Preferably, the at least one contact surface, in particular the plurality of contact surfaces, is located between the inlet and outlet regions. The advantage here is that the dwell time in the charge absorption element and thus the contact time of the charged liquid with the conductive contact surfaces is increased and thus the charge separation can be equalized as completely as possible.

The charge absorption element is preferably an element that is independent of the filter element, in particular the filter layer. In other words, the charge absorption element is preferably structurally separate from the filter element, in particular the filter layer.

In the context of the invention, it is to be understood that not every component of the filter element must be electrically conductive. At least that component of the filter element is electrically conductive which is electrically connected to the filter layer surface and the charge absorption element for charge equalization and which is in conductive contact with the filter layer surface. The contact here can be direct or indirect.

For example, at least one end plate can be conductive, which is in contact with the filter layer surface and is electrically connected to the charge absorption element. Additionally or alternatively, the arrangement can have at least one separate conductive component, in particular at least one electrical line, which electrically connects the filter layer surface and the charge absorption element for charge equalization. The separate component can electrically connect the filter layer surface and the charge absorption element independently of the components of the filter element. It is possible that in this case the filter element is completely non-conductive.

Alternatively or additionally, a separate conductive component can be provided, which is electrically conductively connected to at least one conductive component, for example an end plate and/or a support element, of the filter element and the charge absorption element. This presupposes that the conductive component(s) are conductively coupled with the filter layer and thus the filter layer surface for charge transfer.

The filter layer can be electrically non-conductive. It is possible for the filter layer to have at least one electrically conductive portion. The electrically conductive portion can have at least one conductive thread, in particular several conductive threads.

The filter layer is used to filter, i.e. remove, foreign substances from the liquid. The filter layer can be single-layered or multi-layered. The filter layer can include at least one fabric layer. Preferably, the filter layer has several fabric layers. Additionally or alternatively, the filter layer can include at least one non-woven layer. Other types of layers are possible.

At least one support element can be installed on the outflow side of the filter element, in particular a support tube, which supports the filter layer of the filter element against the direction of flow of the liquid. The support element is preferably a perforated frame. The support element can be electrically conductive at least in portions, in particular completely. In this case, the electrically conductive region of the support element is in contact with the filter layer surface of filter layer for charge transfer. The support element is preferably made of metal. Alternatively, it is possible for the support element to be at least partially non-conductive.

The arrangement is particularly preferably used in filter devices for the filtration of hydraulic oil. The arrangement according to the invention is used in particular in filter devices in mobile hydraulics, e.g. in working machines such as construction machines, agricultural machines or the like, and/or in combination with tank systems. In general, the arrangement according to the invention can be used in filter devices for the filtration of fluids, i.e. gases and other liquids. Other fields of application are possible.

Preferred embodiments of the invention are given in the dependent claims.

In a particularly preferred embodiment, the charge absorption element has a plurality of surface portions which, during operation, absorb electrically charged particles from the liquid and/or transfer them to the liquid, wherein the surface portions are disposed one after the other in the direction of flow, at least in portions. In other words, the surface portions can be at least partially offset from one another in the direction of flow. The surface portions can be separated from one another or at least partially adjacent to one another. It is possible for the surface portions to be disposed in a row. The surface portions can form a common continuous surface, in particular a contact surface. In general, the surface portions form contact surfaces for the liquid to absorb and/or release electrical charges. The surface portions are electrically conductive. In sum, the surface portions provide a large contact surface for the charged liquid. This results in the most efficient possible charge transfer between the charge absorption element and the liquid. This significantly favors the efficiency of charge equalization between the filter element and the liquid.

In a preferred embodiment, the charge absorption element has at least one electrically conductive material structure which is formed from a plurality of cells following one another at least in portions in the direction of flow. In other words, the charge absorption element has a plurality of cells that are passed through by the charged liquid during operation. The material structure is preferably three-dimensional. The cells are advantageously offset from one another in the direction of flow so that the longest possible flow path of the liquid through the charge absorption element is achieved.

In a further preferred embodiment, the cells have a plurality of cell webs, each of which has at least one surface portion, in particular at least one of the plurality of surface portions, which absorbs charges from or releases charges to the liquid during operation. The cell webs can be a foam structure or a fibrous structure. The cell webs can be randomly or specifically aligned. The cell webs are part of the charge absorption element and are therefore electrically conductive. The cell webs can be circular in cross-section, i.e. have a cylindrical surface portion. Alternatively or additionally, the cell webs can have an angular cross-section. Here, the cell webs have at least two surface portions. In this embodiment, it is advantageous that an enlarged contact surface is provided for the charged liquid due to the large number of cell webs.

Preferably, the electrically conductive material structure is a three-dimensional matrix structure. In other words, the electrically conductive material structure is preferably a volume structure with a material matrix. It is possible that the material structure is formed from at least one material ply, in particular a material layer. The material structure can be formed from a single material. The material structure can therefore be in one piece. Alternatively, the material structure can be multi-layered.

Further preferably, the charge absorption element has a three-dimensional outer contour that defines at least one interior space through which a flow can pass and which is filled at least partially, in particular completely by the electrically conductive material structure for absorbing/releasing electrically charged particles. This interior space can be formed by the plurality of cells. However, it is also conceivable that the interior is filled by a plurality of fibers and/or threads. The electrically conductive material structure can therefore be formed from at least one three-dimensional fabric. Alternatively or additionally, the material structure can be formed from at least one three-dimensional grid. Further alternatively or additionally, the material structure can be formed from at least one open-pored foam, in particular plastic foam or metal foam. In one embodiment, the material structure can be formed from a 3D printing material. The charge absorption element can be configured in a variety of ways. The charge absorption element can therefore advantageously be configured to meet specific requirements.

In a preferred embodiment, the charge absorption element has a length of between 20 mm and 250 mm and/or the electrically conductive material structure has a number of pores per inch of at least 5 to 30 pores. The charge absorption element may have a length of 40 mm to 200 mm. More specifically, the charge absorption element may have a length of from 60 mm to 150 mm. Preferably, the charge absorption element has a length of 60 mm to 120 mm. The electrically conductive material structure can have a number of pores per inch of at least 5 to 20 pores. Preferably, the electrically conductive material structure has a number of pores per inch of at least 5 to 15 pores.

In one embodiment, the charge absorption element has a diameter of between 10 mm and 300 mm. The charge absorption element can have a diameter of between 20 mm and 250 mm, in particular between 30 mm and 200 mm. More specifically, the charge absorption element can have a diameter of between 40 mm and 150 mm, in particular between 50 mm and 100 mm. Particularly preferably, the charge absorption element has a diameter of 80 mm.

Particularly preferably, the charge absorption element has a length of 120 mm and the conductive material structure has a number of pores per inch of 10 pores. Test measurements have shown that with a flowable length of the charge absorption element of 120 mm and a number of pores of 10 pores per inch, in particular and a diameter of 80 mm, an improvement in the charge situation of around 80 percent is achieved. In other words, the filter element or the filter layer surface and the liquid are 80 percent less charged due to such a charge absorption element. This results in the formation of only a small electric field, which has a negligible influence on the surrounding electronic components and therefore does not interfere with them.

In an (alternative) embodiment, the charge absorption element has at least one flow channel with at least one surface portion, in particular one of the plurality of surface portions, which in operation absorbs electrical charges from the charged liquid or transfers them to the charged liquid. During operation, the charged liquid flows through the at least one flow channel and contacts the at least one surface portion in order to absorb or release charges. The flow channel can have at least one, in particular several, changes of direction in order to increase the dwell and contact time of the liquid at the surface portions.

The charge absorption element can be a solid component into which the flow channel is integrated. The charge absorption element can have several flow channels. These can be partially connected to each other or separated from each other in the charge absorption element. This embodiment represents a further advantageous way of transporting the charged liquid along an extended flow path through the charge absorption element in order to achieve efficient charge equalization.

The charge absorption element preferably is formed of at least partially of at least one electrically conductive metal material. Alternatively or additionally, the charge absorption element can be formed of at least partially of an electrically conductive plastics material. The material structure and/or the flow channel can include a conductive metal material or a conductive plastics material.

It is particularly preferable for the charge absorption element to be directly or indirectly electrically coupled to the filter element. In the case of indirect coupling the charge absorption element can be electrically connected to the filter element, in particular to a conductive component of the filter element, by a conductive connection part in such a way that charge equalization takes place between the liquid and the filter layer surface during operation. The conductive connection part can be a separate component that is conductively connected to the charge absorption element and the filter element. It is possible that the conductive connection part is part of, for example, at least one conductive end plate that is electrically coupled to the filter layer. Here it is advantageous that the charge absorption element can be positioned flexibly from the filter element, i.e. away from the filter element, for example.

In the case of direct coupling, the charge absorption element can be in direct contact with the filter layer of the filter element in such a way that a charge equalization takes place between the charged filter layer surface and the charged liquid. For this purpose, the charge absorption element can rest against the filter layer in portions. The advantage here is that an additional component is not required.

In a preferred embodiment, the charge absorption element and/or the filter element are floating. Particularly preferably, the charge absorption element and the filter element are floating. This means that the filter element and the charge absorption element are connected to each other in such a way that the charge separation at the filter layer surface is equalized within the arrangement according to the invention. Neither of the two elements is connected to an external mass that could equalize the charge separation. The charge equalization preferably takes place exclusively between the liquid and the filter layer surface. This has the advantage that there is a maximum potential difference and therefore the most efficient charge equalization possible.

In one embodiment, the charge absorption element is disposed outside the filter element in the direction of flow, wherein the charge absorption element is attached to the filter element. In other words, the charge absorption element is downstream of the filter element in the direction of flow, i.e. downstream of a liquid outlet opening of the filter element. The charge absorption element is attached directly or indirectly to the filter element, for example. When the arrangement is installed, the filter element performs a holding function for the charge absorption element. This has the advantage that, for example, when the arrangement is used in a filter housing, no connection needs to be provided on the filter housing to hold the charge absorption element in position.

Preferably, the arrangement according to the invention includes at least one holding device with at least one flow opening, wherein the charge absorption is disposed in the holding device and the holding device is connected to an end plate of the filter element. The holding device preferably includes a holding basket in which the charge absorption element is accommodated. The holding device can be attached to the end plate detachably. The holding device can be connected to the end plate form-lockingly or in a frictionally engaged manner. The flow opening serves as an outlet opening for the discharged liquid after it has passed through the charge absorption element. The advantage here is that the attachment of the holding device to the end plate is simple and inexpensive to implement.

The holding device can have a circumference or periphery that is at least partially closed in the longitudinal direction of the holding device. The flow opening forms a passage through the circumference or periphery of the holding device. The flow opening can be formed in the longitudinal direction of the holding device in the region of a first end of the holding device. The first end is an end of the holding device facing away from the filter element. The flow opening is preferably disposed in a longitudinal half of the holding device adjacent to the first end. Preferably, the holding device has several flow openings distributed around the circumference or periphery. It is advantageous here that the charged liquid does not exit the charge absorption element immediately upon entering it, but in the second longitudinal half of the holding device. This has a beneficial effect on charge equalization due to the increased dwell time of the liquid in the charge absorption element.

In a further embodiment, the filter element, in the longitudinal direction, has a central flow opening, in which the charge absorption element is disposed at least in portions. In other words, the filter element is preferably hollow-cylindrical, wherein the charge absorption element disposed inside. In this case, the liquid flows through the filter element from the outside to the inside, so that the charged liquid is passed through the charge absorption element. This embodiment represents a compact configuration of the arrangement, as the charge absorption element is integrated into the central flow opening of the filter element, at least in portions.

In a further embodiment, the charge absorption element is disposed running around the outside of the filter element, at least in portions. In other words, the charge absorption element can be disposed on the outside of the filter element in the circumferential direction. In the installed state of the arrangement, an annular gap is provided between the filter element and an inner wall of a filter housing. The charge absorption element can be disposed in this annular gap, for example. In this case, the liquid flows through the filter element from the inside to the outside so that the charged liquid is passed through the charge absorption element. Here too it is advantageous that the arrangement has a compact configuration. Additional brackets, e.g. on an end plate or similar, can be omitted.

The arrangement according to the invention can have at least one support element, in particular a perforated frame, wherein the support element supports the filter element on the outflow side. The support element is preferably formed here by the charge absorption element. In other words, the charge absorption element can have a region that supports the filter layer. This eliminates the need for a separate support element, thus saving costs. In particular, in this embodiment, the charge absorption element can be integrated into the central flow opening of the filter element.

With the objects of the invention in view, according to a secondary aspect, there is also provided a filter device for filtering a liquid, in particular hydraulic oil, with an arrangement according to the invention, and a filter housing, in particular a filter bowl, in which the filter element is disposed in a replaceable manner, wherein the charge absorption element is disposed in or on the filter housing. Reference is made here to the advantages explained in conjunction with the arrangement. Furthermore, the filter device may alternatively or additionally have individual features or a combination of several features mentioned above in relation to the arrangement.

The filter housing can have at least one housing portion with an outlet opening for the filtered or charged liquid, on which the charge absorption element is disposed. The filter device can have at least one holding device, in particular a holding basket, in which the charge absorption element is disposed at least in portions, wherein the holding device is attached to the housing portion. The housing portion can include a form-locking geometry via which the holding device can be detachably connected to the filter housing form-lockingly. Additionally or alternatively, the holding device can be connected to the housing portion in a frictionally engaged manner, in particular screwed. In this case, it is advantageous that the charge absorption element is disposed on the filter housing independently of the filter element. The charge absorption element can be structurally separate from the filter element. In this embodiment, the filter housing includes the necessary receptacle to fix the holding device. The filter element as such can be simplified as a result, since holding geometries, e.g. on an end plate, are no longer required. Furthermore, accessibility for assembly and disassembly is facilitated.

In one embodiment of the filter device according to the invention, the filter housing has at least one intermediate space, which is formed between an inner wall of the filter housing and an outer circumference or periphery of the filter element, wherein the charge absorption element is disposed in the intermediate space. The intermediate space can be an annular space. In this embodiment, the air flows through the filter element from the inside to the outside. The charge absorption element can be hollow-cylindrical. This gives the filter device a compact configuration.

With the objects of the invention in view, according to a further secondary aspect, there is furthermore provided a tank system with at least one container for a liquid, in particular hydraulic oil, at least one arrangement according to the invention and/or at least one filter device according to the invention, wherein the filter device and/or the arrangement on the container is/are provided in such a way that the filtered liquid flows into the container during operation. Due to the arrangement or filter device according to the invention, the filtered liquid in the container is slightly charged or even completely discharged. As a result, an electric field is only built up with low strength, so that the influence of the electric field on surrounding electronic components is low. In the best case scenario, no electric field is created.

In one embodiment of the tank system according to the invention, the charge absorption element at least partially fills the interior of the container, wherein the charge absorption element is structurally separated from the filter device and/or from the filter element. The load receiving element is preferably at a distance from the filter device in the interior of the container. The charge absorption element can be disposed on a container base, with the outlet opening of the filter device located above the charge absorption element. Irrespective of the installation position of the filter device, the charge absorption element is located downstream of the outlet opening of the filter device so that the filtered and charged liquid flows through the charge absorption element during operation. It is possible for the charge absorption element to substantially completely fill the interior of the container. Specifically, it is conceivable that the interior of the container is filled with foam, wherein the foamed volume forms the charge absorption element. The advantage here is that the filter element and the filter housing are configured to be simple and cost-effective, as there is no need for corresponding holding geometries to hold the charge absorption element.

With the objects of the invention in view, according to a further secondary aspect, there is concomitantly provided a method for charge equalization between a filter element and a liquid, in particular hydraulic oil, in which an arrangement, in particular an arrangement according to the invention, is provided with a filter element for filtering the liquid and at least one charge absorption element for receiving electrically charged particles of the liquid. The filter element and the charge absorption element are at least partially electrically conductive. The filter element has at least one filter layer with a filter layer surface. The liquid flows through the filter layer surface and the charge absorption element. Charge separation takes place on the filter layer surface as the liquid flows through, wherein the charge absorption element is electrically connected to the filter element in such a way that charge separation is equalized between the charge absorption element and the filter layer surface. The charge absorption element is connected downstream of the filter element in the direction of flow.

Reference is made here to the advantages explained in conjunction with the arrangement, the filter device or the tank system. Furthermore, the method can alternatively or additionally have individual or a combination of several of the features described previously with regard to the arrangement, the filter device or the tank system.

Other features which are considered as characteristic for the invention are set forth in the appended claims.

Although the invention is illustrated and described herein as embodied in an arrangement with a filter element and a charge absorption element, a filter device, a tank system and a method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

The embodiments shown represent examples of how the arrangement according to the invention, the filter device according to the invention and the tank system according to the invention can be configured.

### BRIEF DESCRIPTION OF THE FIGURES

FIG. 1 is a diagrammatic, longitudinal-sectional view of a filter device with an arrangement according to a preferred exemplary embodiment according to the invention;

FIG. 2 is a longitudinal-sectional view of a filter device with an arrangement according to a further preferred embodiment according to the invention;

FIG. 3 is a longitudinal-sectional view of a filter device with an arrangement according to a further preferred exemplary embodiment according to the invention;

FIG. 4 is a longitudinal-sectional view of a diagrammatically depicted tank system according to an exemplary embodiment according to the invention;

FIG. 5 is a longitudinal-sectional view of a diagrammatically depicted tank system according to a further exemplary embodiment according to the invention;

FIG. 6 is a simulated field line image of a tank system from the prior art;

FIG. 7 is a side-elevational view of two holding devices for a charge absorption element of the filter device according to FIG. 1;

FIG. 8 is a side-elevational view of three further holding devices for a charge absorption element of the filter device according to FIG. 1; and

FIG. 9 includes detail views with different pore sizes of a charge absorption element of a filter device according to one of FIGS. 1 to 3 and/or a tank system according to FIG. 4 or 5.

### DETAILED DESCRIPTION OF THE INVENTION

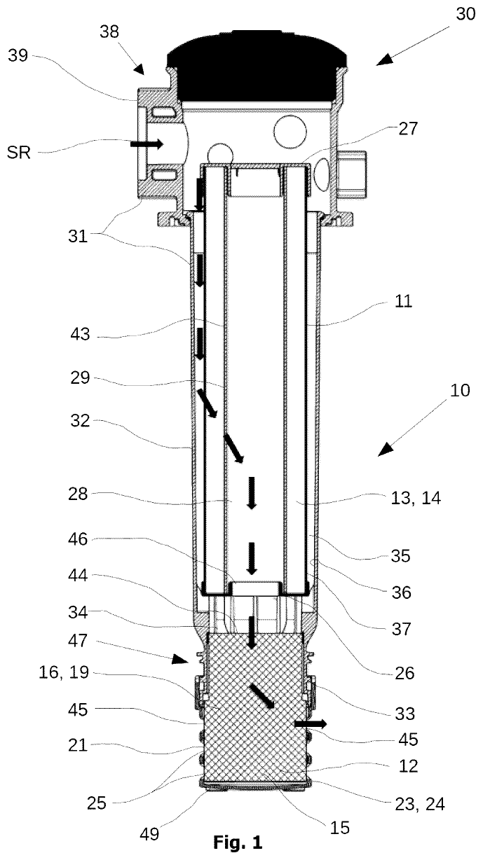

Referring now to the figures of the drawings in detail and first, particularly, to FIGS. 1-5 thereof, it is seen that each figure shows a filter device 30 with an arrangement 10 according to a preferred exemplary embodiment according to the invention. The filter device 30 is used to filter a liquid, i.e. to remove foreign substances from a liquid. The filter device 30 shown in FIGS. 1 to 5 is preferably used for the filtration of hydraulic oil. The filter device 30 is not limited to the filtration of hydraulic oil. It is possible to use the filter device 30 to filter other fluids, in particular other liquids. In the following description, the liquid is generally referred to as hydraulic oil.

The filter device 30 as shown in FIGS. 1 to 5 includes the arrangement 10 with a filter element 11 for filtering hydraulic oil and a charge absorption element 12 for receiving electrically charged particles of the hydraulic oil. The filter element 11 has a filter layer 13 with a filter layer surface 14. The filter layer 13 is pleated. In other words, the filter layer 13 is folded. Such a configuration is generally known, so that it will not be discussed further.

The hydraulic oil can flow through the filter layer surface 14 and the charge absorption element 12. During operation, when the hydraulic oil flows through the filter layer 13, charge separation occurs at the filter layer surface 14. The filter layer surface 14 and the hydraulic oil are charged in opposite directions. For example, the filter layer surface 14 can be negatively charged, i.e. have an excess of electrons, and the filtered hydraulic oil can be positively charged, i.e. have a lack of electrons. Alternatively, it is also possible that the charge separation can result in the filter layer surface 14 being positively charged and the hydraulic oil being negatively charged. Depending on the corresponding charge, the filter layer surface 14 and the hydraulic oil each have an opposite polarity. Charge carriers in the hydraulic oil are referred to as ions.

The charge absorption element 12 is connected downstream of the filter element 11 in the direction of flow SR. The charge absorption element 12 is therefore passed through by the charged hydraulic oil after the filtration. The charge absorption element 12 is electrically connected to the filter element 11 in such a way that the charge separation between the charge absorption element 12 and the filter layer surface 14 is equalized during operation. Since the filter layer surface 14 and the hydraulic oil are charged in opposite directions, there is a high potential difference between them. The electrical connection will be discussed in greater detail later.

Due to the high potential difference, the hydraulic oil releases charged particles to the charge absorption element 12 or absorbs charged particles from the charge absorption element 12. This depends on the polarity of the charged filter layer surface 14 and the charged hydraulic oil. Depending on the polarity, these charged particles are transported through an electrical connection between the filter element 11 and the charge absorption element 12, so that the charge separation is equalized. To equalize the charge separation, electrons flow between the filter layer surface 14 and the charge absorption element 12. The previously generated charge of the filter layer surface 14 or the filter element 11 and the hydraulic oil is thus retroactively equalized again. This considerably reduces the electrostatic charge of the filter layer 13 and the hydraulic oil.

FIG. 6 shows an example of a field line image from the prior art in which it is simulated how the electrical charges are distributed in a hydraulic tank on which a filter device is disposed. The filter device is negatively charged and the hydraulic oil in the hydraulic tank is positively charged. It can be seen that the charge ratios result in a strong electric field eF (see black, continuous lines), which exits outwardly through the tank wall when the tank is not shielded. As a result, surrounding electronic components are negatively affected or even destroyed. This problem is solved by the filter device 30 or the tank system 40 according to FIGS. 1 to 5.

As can be seen in FIGS. 1 to 5, the filter device 30 has a filter housing 31 with a filter bowl 32 and a filter head 38. The filter head 38 includes a connection 39 through which hydraulic oil enters the filter device 30 during operation. The filter head 38 is tightly connected to the filter bowl 32. Preferably the filter bowl 32 is hooked into the filter head 38. The filter head 38 and the filter bowl 32 can be screwed together.

The filter element 11 is disposed in the filter housing 31 in a replaceable manner. A large part of the filter element 11 is disposed in the filter bowl 32. As described above, the filter element 11 has the filter layer 13. In addition, the filter element 11 includes two end plates 26, 27, into which the filter layer 13 sits with its end faces. The end plates 26, 27 are disposed opposite each other on the two end faces of the filter layer 13 in the longitudinal direction of the filter element 11. The end plate 27 facing the filter head 38 is closed in the filter device 30 according to FIGS. 1, 2 and 4 and the opposite end plate 26 is open. The filter layers 13 of the filter elements 11 as shown in FIGS. 1, 2 and 4 are passed through from the outside to the inside during operation.

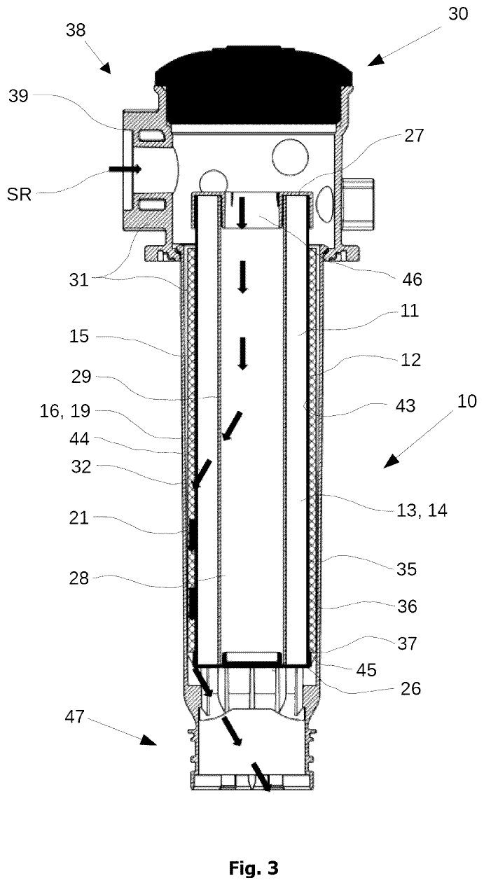

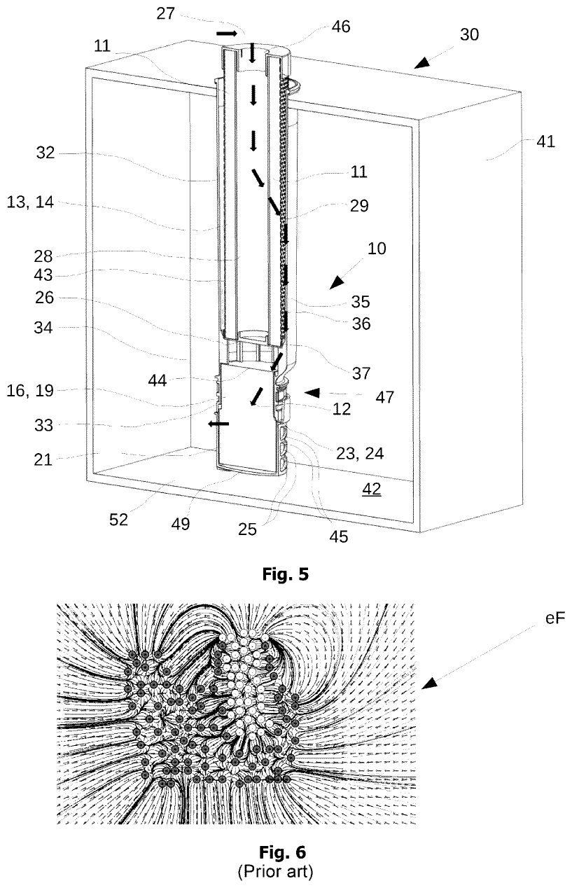

The end plate 27 of the filter device shown in FIGS. 3 and 5, on the other hand, is open and the opposite end plate 26 is closed. The flow through the filter layer 13 of the filter element 11 is from the inside to the outside during operation. The direction of flow SR is indicated by black arrows in FIGS. 1 to 4.

The filter element 11 has a radially inner central flow opening 28. The central flow opening 28 extends substantially across the entire length of the filter element 11. Furthermore, the filter element 11 has a support element 29, which is disposed on an outflow side 43 of the filter layer 13. The support element 29 supports the filter layer 13 against the direction of flow SR of the hydraulic oil. The support element 29 has a large number of passages so that the hydraulic oil can flow through it. The support element 29 is a perforated frame in the filter element 11 according to FIGS. 1 to 5. Other configurations of the support element 29 are possible.

The charge absorption element 12, which is shown as a cross-hatched body in FIGS. 1 to 5, is described in greater detail below. The respective charge absorption element 12 of the filter devices 30 according to FIGS. 1 to 5 is completely electrically conductive. The charge absorption element 12 is electrically coupled to the filter element 11 in such a way that a charge equalization takes place between the hydraulic oil and the filter layer surface 14.

The charge absorption element 12 serves to receive charges from the hydraulic oil and/or to release charges to the hydraulic oil. The charge absorption element 12 thus forms at least one mechanism for charge transfer. During operation, the hydraulic oil flows through the charge absorption element 12 downstream of the filter element 11 in the direction of flow SR. As can be seen in FIGS. 1 to 5, the charge absorption element 12 is disposed downstream of the support element 29 in the direction of flow SR. The exact position of the charge absorption element 12 in the filter devices 30 according to FIGS. 1 to 5 will be discussed later.

The charge absorption element 12 includes an inlet region 44 and an outlet region 45 for the filtered hydraulic oil. The charge absorption element 12 is configured in such a way that several flow paths are provided between the inlet region 44 and the outlet region 45. The flow paths each have a length that is longer than a shortest flow path between the inlet and outlet regions 44, 45. In other words, the charge absorption element 12 is configured in such a way that several flow paths between the inlet and outlet regions 44, 45 are extended with respect to a minimum flow path between the inlet and outlet regions 44, 45.

The charge absorption element 12 has a three-dimensional shape. Specifically, the charge absorption element 12 has an electrically conductive material structure 16 including a three-dimensional matrix structure 19. The electrically conductive material structure 16 has a plurality of surface portions 15, which the hydraulic oil contacts as it flows through. The surface portions 15 thus form contact surfaces for the hydraulic oil in order to absorb charges from the hydraulic oil or to transfer charges to the hydraulic oil. The surface portions 15, in particular the contact surfaces, are electrically conductive.

The electrically conductive material structure 16 can be made of an electrically conductive metal material and/or an electrically conductive plastics material. The electrically conductive material structure 16 can be formed by a conductive open-pored foam element 22. The foam element 22 can be a metal foam 22 or a plastics foam. It is possible that the electrically conductive material structure 16 is formed by several, in particular at least two, foam elements 22, which are disposed adjacent to one another. FIG. 9 shows three examples of detailed images of foam elements 22 with different numbers of pores per inch. It can be seen here that the foam elements have cells 17 with cell webs 18. The cell webs 18 include the surface portions 15, to which the hydraulic oil releases charges or absorbs charges depending on the polarity.

When one or more foam elements are used, these preferably have a number of pores per inch of at least 5 to 30 pores, particularly preferably 10 pores.

Alternatively, the electrically conductive material structure 16 can be formed by a three-dimensional grid or a three-dimensional fabric. The three-dimensional fabric can be formed from a large number of layers of fabric lying on top of each other. The threads of the fabric are electrically conductive. The electrically conductive material structure 16 can be produced by 3D printing, in particular by sintered 3D printing. In summary, the electrically conductive material structure 16 can be foamed, open-pored, porous, lattice-like, woven, mesh-like, braided or formed from one or more combinations thereof.

In each of the variants mentioned, i.e. in the foam element, the grid and the fabric, the flow paths or surface portions 15 described above are provided.

The conductive material structure 16 is located between the inlet and outlet regions 44, 45 of the charge absorption element 12. Thus, the flow paths, in particular the surface portions 15, are also disposed between the inlet and outlet region 44, 45.

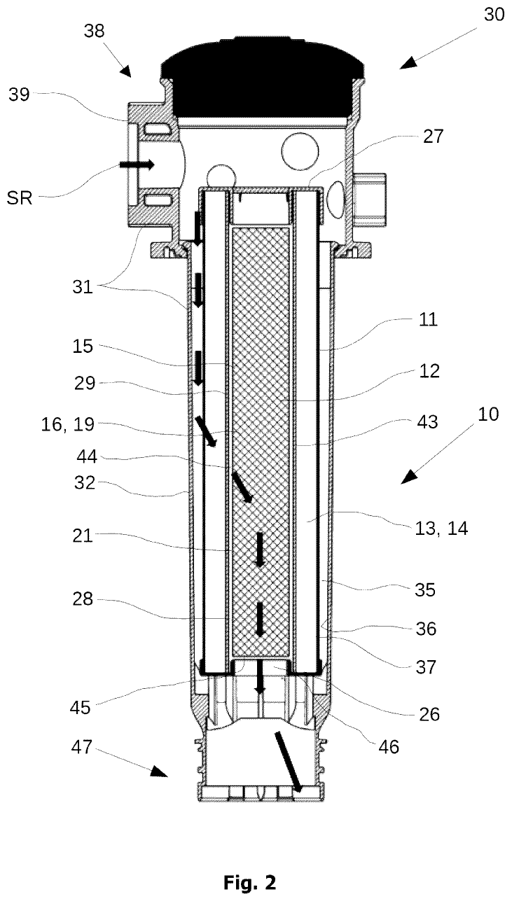

As can be seen from FIGS. 1 to 5, the inlet and outlet regions 44, 45 are angularly offset from one another. Specifically, in the case of the charge absorption element 12 according to FIGS. 1, 4 and 5, the inlet region 44 is disposed at the top and the outlet region 45 at the side in the installed position. In the case of the charge absorption elements 12 according to FIGS. 2 and 3, the inlet region 44 is disposed at the side and the outlet region 45 at the bottom in the installed position. Of course, other positions of the inlet and outlet regions 44, 45 are possible.

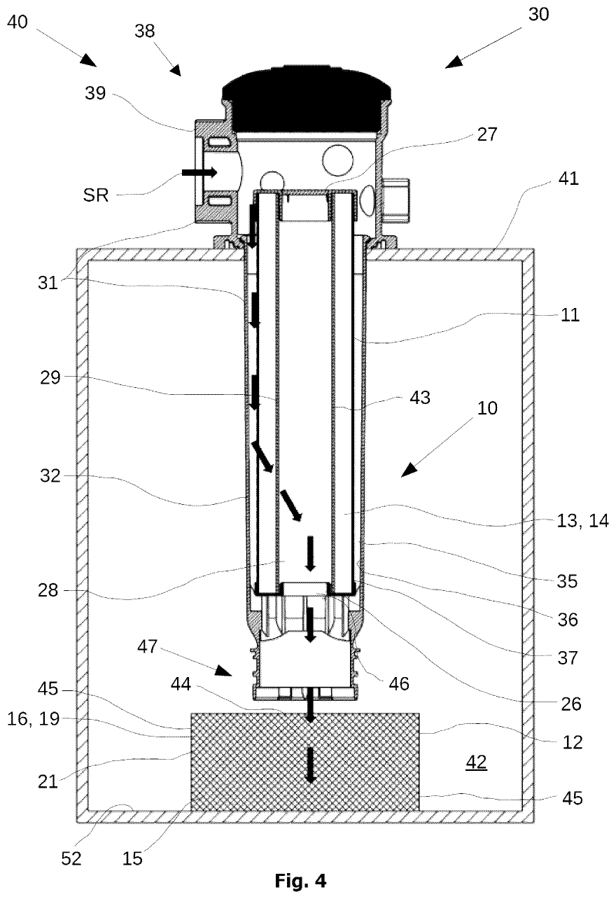

According to FIGS. 1 to 5, the charge absorption elements 12 have a different shape and size depending on their position. In general, the charge absorption elements 12 each have a three-dimensional outer contour 21. For example, the charge absorption element 12 according to FIGS. 1, 2 and 5 is fully cylindrical. These differ only in diameter and length. According to FIG. 3, the charge absorption element 12 is hollow-cylindrical. The charge absorption element 12 according to FIG. 4 can be fully cylindrical or rectangular. Other volumetric shapes of the charge absorption elements 12 are possible. In general, the charge absorption elements 12 each have a length of between 20 and 250 mm.

In the filter device 30 according to FIGS. 1 to 5, the charge absorption element 12 is a structurally separate element from the filter element 11. In other words, the charge absorption element 12 is disposed independently of the filter element 11. The charge absorption element 12 is therefore separated from the filter element 11. As can be seen in FIGS. 1 to 5, the charge absorption element 12 is disposed downstream of the support element 29 of the filter element 11 in the direction of flow SR. In the filter devices 30 according to FIGS. 1 to 5, the charge absorption element 12 is therefore also separated from the support element 29 structurally. However, this does not rule out the possibility that the charge absorption element 12 may rest against the support element 29, as in FIG. 2 or 3, for example.

According to FIGS. 1 and 5, the charge absorption element 12 is disposed outside the filter element 11. FIG. 1 shows the filter device 30 as such and FIG. 5 shows a tank system 40 with a filter device 30, which is similar to the filter device in FIG. 1 except for the direction of flow. As can be seen in FIG. 5, the filter device 30 protrudes into the tank 40 so that the filter bowl 32 is partially immersed in hydraulic oil during operation. To simplify the illustration, the filter head 38 is hidden in FIG. 5.

Specifically, the charge absorption element 12 is disposed downstream of the end plate 26 of the filter element 11 in the direction of flow SR. The charge absorption element 12 is at a distance from the end plate 26. Specifically, the charge absorption element 12 is spaced from the end plate 26 in the longitudinal direction of the filter device 30, in particular the filter bowl 32. The end plate 26 has an opening 46, through which the charged hydraulic oil exits the filter element 11 and then, through the inlet region 44, enters the electrically conductive material structure 16 of the charge absorption element 12.

The filter bowl 32 of the filter device 30 has a housing portion 33 with an outlet opening 34. The charge absorption element 12 is partially disposed in the housing portion 33. The housing portion 33 forms a free end 47 of the filter bowl 32. The housing portion 33 includes a form-locking geometry on an outer circumference or periphery for connection to a holding device 23. Specifically, the filter device 30 includes a holding device 23 which can be connected to the housing portion 33. In the connected state, the holding device 23 holds the charge absorption element 12 on the housing portion 33. The holding device 23 has a mating geometry to the form-locking geometry of the housing portion 33. The holding device 23 can therefore be connected form-lockingly to the housing portion 33. The holding device 23 can be fastened to the housing portion 33 by using a bayonet catch. Alternatively, the holding device 23 can be screwed to the housing portion 33. Additionally or alternatively, a snap connection between the holding device 23 and the housing portion 33 is possible. FIGS. 1 and 5 show the connected state of the holding device 23 and the housing portion 33.

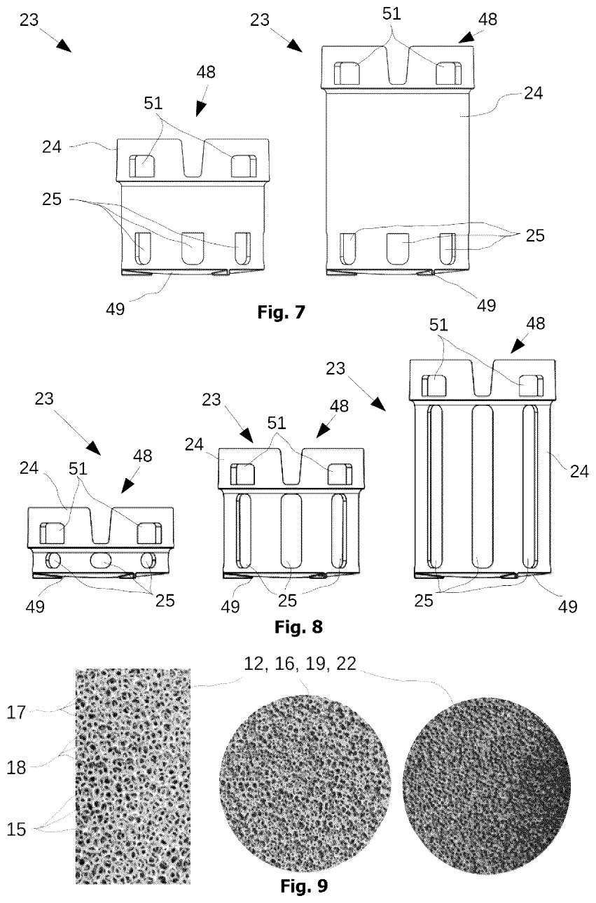

FIGS. 7 and 8 show examples of the configuration of the holding device 23. It is easy to see here that the holding device 23 is a holding basket 24, in which the charge absorption element 12 is at least partially disposed. It is possible that the charge absorption element 12 can be disposed completely in the holding basket 24. It can also be seen that the two holding baskets 24 shown in FIGS. 7 and 8 differ only in their overall length and the length of flow openings 25. For example, according to FIG. 7, the holding basket 24 shown on the left can accommodate a charge absorption element 12 which is 60 mm in length and the holding basket 24 shown on the right can accommodate a charge absorption element 12 which is 120 mm in length. In FIG. 8, this applies to the middle and right-hand holding basket 24. The holding basket 24 shown on the left in FIG. 8 can hold a charge absorption element 12 which is 20 mm long.

The holding baskets 24 have an open end 48 and a closed end 49 which are opposite each other in the longitudinal direction. In the connected state, the open end 48 faces the housing portion 33 of the filter bowl 32. In the connected state, the closed end 49 faces away from the housing portion 33 of the filter bowl 32.

At the open end 48, the holding baskets 24 have a plurality of passages 51 distributed on the outer circumference or periphery, which are used for form-locking connection to the housing portion 33. The passages 51 correspond to the aforementioned mating geometry.

Furthermore, the holding baskets 24 have a plurality of flow openings 25 distributed around an outer circumference or periphery, through which the discharged hydraulic oil can exit from the charge absorption element 12.

The flow openings 25 according to FIG. 7 are formed in the longitudinal direction of the holding basket 24 in the region of the closed end 49. The flow openings 25 are disposed in a longitudinal half of the holding basket 24 adjacent to the closed end 49. In contrast to FIG. 7, the holding baskets 24 have a plurality of flow openings 25 distributed on an outer circumference or periphery, which extend substantially over the entire length of the holding baskets 24. Specifically, the flow openings 25 run between the mating geometry and the closed end 49 of the holding baskets 24. The flow openings 25 according to FIGS. 7 and 8 are elongated slots. Other shapes are possible.

According to FIG. 2, the charge absorption element 12 is integrated into a central flow opening 28 of the filter element 11. Specifically, the charge absorption element 12 is disposed in the support element 29 of the filter element 11. The charge absorption element 12 is disposed between the two end plates 26, 27 of the filter element 11.

In the filter device 30 according to FIG. 3, the charge absorption element 12 is disposed in an intermediate space 35, which is located between an inner wall 36 of the filter bowl and an outer circumference or periphery 37 of the filter element 11. The charge absorption element 12 is disposed here on the outer circumference or periphery of the filter element 11, specifically on an outer circumference or periphery of the support element 29.

According to FIG. 4 a tank system 40 is shown, including a container 41 and a filter device 30. In contrast to the filter devices 30 according to FIGS. 1, 2, 3 and 5, the charge absorption element 12 is disposed outside the filter housing 31 in the filter device 30 according to FIG. 4. Specifically, the charge absorption element 12 is disposed outside the filter bowl 32. As can be seen in FIG. 4, the filter device 30 protrudes into the container 41 so that the filter bowl 32 is partially in the hydraulic oil during operation. The charge absorption element 12 is disposed on a base 52 of the container 41. The charge absorption element 12 is disposed completely in an interior 42 of the container 41. In the installation position of the container 41, the charge absorption element 12 is disposed below an outlet opening 34 of the filter bowl 32. The inlet region 44 of the charge absorption element 12 is spaced from the outlet opening 34. Alternatively, the inlet region 44 of the charge absorption element 12 can rest against the outside of the filter bowl 32 in the region of the outlet opening 34.

As described above, the filter element 11 is electrically connected to the charge absorption element 12 in order to equalize the charge between the hydraulic oil and the filter layer surface 14. The electrical connection is not shown in FIGS. 1 to 5. The filter layer 13 of the filter element 11 can be non-conductive or conductive. The filter layer 13 and thus the filter layer surface 14 is electrically conductively connected to the charge equalization element 12. This can be achieved via direct contact between the filter layer 13 and the charge absorption element 12 or indirectly via a conductive element, such as a conductive end plate 26, 27, a conductive support element 29 or a separate conductive component. The separate conductive component can be an electrical cable, for example. Other conductive mechanisms for electrically connecting the filter layer 13 and the charge absorption element 12 are possible.

The following is a summary list of reference numerals and the corresponding structure used in the above description of the invention:
10 arrangement
11 filter element
12 charge absorption element
13 filter layer
14 filter layer surface
15 surface portion
16 electrically conductive material structure
17 cells
18 cell webs
19 three-dimensional matrix structure
21 three-dimensional outer contour
22 open-pored foam
23 holding device
24 holding basket
25 flow opening
26, 27 end plates
28 central flow opening
29 support element
30 filter device
31 filter housing
32 filter bowl
33 housing portion
34 outlet opening
35 intermediate space
36 inner wall of the filter housing
37 outer circumference or periphery
38 filter head
39 connection
40 tank system
41 container
42 interior space of the container
43 outflow side
44 entry region
45 exit region
46 opening of the end plate
47 free end of the filter bowl
48 open end
49 closed end
51 passage
52 base
SR flow direction

1. An arrangement, comprising:
a filter element for filtering a liquid, in particular hydraulic oil, said filter element having at least one filter layer with a filter layer surface;
at least one charge absorption element for receiving electrically charged particles of the liquid, said at least one charge absorption element being connected downstream of said filter element in a direction of flow;
said filter element and said at least one charge absorption element being electrically conductive;
said filter layer surface and said at least one charge absorption element configured to be passed through by the liquid, with a charge separation taking place on said filter layer surface as the liquid flows through; and
said at least one charge absorption element being electrically connected to said filter element, causing the charge separation to be equalized between said at least one charge absorption element and said filter layer surface during operation.

2. The arrangement according to claim 1, wherein said at least one charge absorption element has a plurality of surface portions configured to receive the electrically charged particles during operation, said surface portions being disposed in succession at least in portions in the direction of flow.

3. The arrangement according to claim 2, wherein said at least one charge absorption element has at least one electrically conductive material structure formed from a plurality of cells following one another at least in portions in the direction of flow.

4. The arrangement according to claim 3, wherein said cells have a plurality of cell webs, each of said plurality of cell webs having at least one surface portion, or at least one of said plurality of surface portions, receiving the electrically charged particles during operation.

5. The arrangement according to claim 3, wherein said at least one electrically conductive material structure is a three-dimensional matrix structure.

6. The arrangement according to claim 3, wherein said at least one charge absorption element has a three-dimensional outer contour defining at least one interior space through which a flow can pass, said at least one electrically conductive material structure for receiving electrically charged particles at least partially or completely filling said at least one interior space.

7. The arrangement according to claim 2, wherein said at least one charge absorption element has at least one of:
a length of from 20 mm to 250 mm, or
at least one electrically conductive material structure formed from a plurality of cells following one another at least in portions in the direction of flow with at least 5 to 30 pores per inch.

8. The arrangement according to claim 7, wherein said length of said at least one charge absorption element is from 60 mm to 120 mm.

9. The arrangement according to claim 3, wherein said at least one charge absorption element or said at least one electrically conductive material structure is formed of at least one of:
at least one three-dimensional fabric, or
at least one three-dimensional grid, or
at least one open-pored foam, or
plastics foam, or
metal foam, or
a 3D printing material.

10. The arrangement according to claim 2, wherein said at least one charge absorption element has at least one flow channel with at least one surface portion or with one of said plurality of surface portions receiving the electrically charged particles during operation.

11. The arrangement according to claim 1, wherein said at least one charge absorption element has at least one of a material structure or a flow channel, and at least one of said at least one charge absorption element or said material structure or said flow channel is formed at least partially of at least one of at least one electrically conductive metal material or an electrically conductive plastics material.

12. The arrangement according to claim 1, wherein said at least one charge absorption element is directly or indirectly electrically coupled to said filter element.

13. The arrangement according to claim 1, wherein at least one of said at least one charge absorption element or said filter element are floating.

14. The arrangement according to claim 1, wherein said at least one charge absorption element is disposed outside said filter element in the direction of flow, and said at least one charge absorption element is attached to said filter element.

15. The arrangement according to claim 1, wherein:
said filter element has an end plate;
at least one holding device or holding basket has at least one flow opening;
said at least one charge absorption element is disposed in said at least one holding device; and
said at least one holding device is connected to said end plate.

16. The arrangement according to claim 15, wherein said at least one holding device has a periphery being at least partially closed in a longitudinal direction of said at least one holding device.

17. The arrangement according to claim 1, wherein said filter element has a central flow opening in a longitudinal direction, and at least portions of said at least one charge absorption element are disposed in said central flow opening.

18. The arrangement according to claim 1, wherein said at least one charge absorption element is disposed around at least portions of an outside of said filter element.

19. The arrangement according to claim 1, which further comprises at least one support element or perforated frame supporting said filter element on an outflow side, said at least one support element or perforated frame being formed by said at least one charge absorption element.

20. A filter device for the filtration of a liquid or of hydraulic oil, the filter device comprising:
an arrangement according to claim 1; and
a filter housing or filter bowl;
said filter element being disposed in said filter housing or filter bowl in a replaceable manner; and
said at least one charge absorption element being disposed in or on said filter housing or filter bowl.

21. The filter device according to claim 20, wherein said filter housing has at least one housing portion with an outlet opening for filtered liquid, and said at least one charge absorption element is disposed on said at least one housing portion for receiving electrically charged particles from the liquid.

22. The filter device according to claim 21, which further comprises at least one holding device or holding basket, at least portions of said at least one charge absorption element being disposed in said at least one holding device or holding basket, and said at least one holding device or holding basket being fastened to said at least one housing portion.

23. The filter device according to claim 20, wherein said filter housing has an inner wall, said filter element has an outer periphery, said inner wall and said outer periphery define at least one intermediate space of said filter housing therebetween, and said at least one charge absorption element is disposed in said intermediate space.

24. A tank system, comprising:
at least one container for a liquid or for hydraulic oil; and
at least one arrangement according to claim 1;
said at least one arrangement being disposed at said container to cause filtered liquid to flow into said container during operation.

25. A tank system, comprising:
at least one container for a liquid or for hydraulic oil; and
at least one filter device according to claim 20;
said at least one filter device being disposed at said container to cause filtered liquid flows into said container during operation.

26. The tank system according to claim 25, wherein said at least one charge absorption element at least partially fills an interior of said at least one container, and said at least one charge absorption element is structurally separated from at least one of said filter device or said filter element.

27. A method for charge equalization between a filter element and a liquid or hydraulic oil, the method comprising:
providing an arrangement having a filter element for filtering the liquid and at least one charge absorption element for receiving electrically charged particles of the liquid;
the filter element and the at least one charge absorption element being at least partially electrically conductive;
providing the filter element with at least one filter layer having a filter layer surface;
passing the liquid through the filter layer surface and the at least one charge absorption element and carrying out a charge separation at the filter layer surface as the liquid flows through;
electrically connecting the at least one charge absorption element to the filter element to equalize the charge separation between the at least one charge absorption element and the filter layer surface; and
connecting the at least one charge absorption element downstream of the filter element in a direction of flow.
